(19) United States
(12) Patent Application Publication
(10) Pub. No.: US 2026/0189881 A1
(43) Pub. Date: Jul. 2, 2026

(54) NON-TRANSITORY COMPUTER-READABLE RECORDING MEDIUM STORING COMPUTER-READABLE INSTRUCTIONS FOR SERVER, METHOD FOR DISPLAYING SCREEN ON TERMINAL DEVICE, AND COMMUNICATION SYSTEM

(71) Applicant: BROTHER KOGYO KABUSHIKI KAISHA, Nagoya (JP)

(72) Inventor: Takeshi SHIOTANI, Nagoya (JP)

(21) Appl. No.: 19/395,094

(22) Filed: Nov. 20, 2025

(30) Foreign Application Priority Data
Dec. 26, 2024 (JP) 2024-230345

(51) Int. Cl. H04W 4/12

(52) U.S. Cl. CPC H04W 4/12

(57) ABSTRACT

The server may receive a first generation request from the first terminal device under a first login state. The server may generate specific notification information and store specific account information, the notification identification information, device identification information and the specific notification information in association with each other in a memory. The server may receive a first request signal from the first terminal device and send the first terminal device the specific notification information. The first terminal device may display the specific notification information. The server may, after the specific account information, the notification identification information, the device identification information and the specific notification information have been stored in association with each other and under a second login state, receive a second request signal from a second terminal device and send the second terminal device the specific notification information. The second terminal device may display the specific notification information.

### REFERENCE TO RELATED APPLICATION

This application claims priority to Japanese Patent Application No. 2024-230345 filed on December 26, 2024. The entire content of the priority application is incorporated herein by reference.

### BACKGROUND ART

A communication system is known that includes a plurality of MFPs, a terminal device, a notification server, a service providing server, and a service management server. The terminal device sends a pull notification information request to the notification server and receives pull notification information from the notification server. The terminal device stores the pull notification information received from the notification server in a memory of the terminal device. In response to receiving an operation on a button for displaying a notification list screen, the terminal device displays a notification list screen including a list of notification information stored in the memory of the terminal device.

### SUMMARY

The disclosure herein provides teachings to improve user convenience pertaining to notification information.

The disclosure herein discloses a non-transitory computer-readable recording medium storing computer-readable instructions for a server. The computer-readable instructions, when executed by a processor of the server, may cause the server to, under a first login state where a first terminal device is logged in to the server using specific account information, receive a first generation request from the first terminal device. The first generation request may include notification identification information for identifying specific notification information and device identification information for identifying a specific communication device. The specific notification information may be for notifying a user of the specific communication device of existence of a service for the specific communication device. The computer-readable instructions, when executed by the processor, may cause the server to, in a case where the first generation request is received, generate the specific notification information corresponding to the notification identification information. The computer-readable instructions, when executed by the processor, may cause the server to, after the specific notification information has been generated, store the specific account information, the notification identification information, the device identification information and the specific notification information in association with each other in a memory. The computer-readable instructions, when executed by the processor, may cause the server to, after the specific notification information has been generated, receive, from the first terminal device, a first request signal requesting sending of notification information associated with the specific account information. The computer-readable instructions, when executed by the processor, may cause the server to, in a case where the first request signal is received from the first terminal device, send the first terminal device the specific notification information associated with the specific account information. The first terminal device may display the specific notification information in a case where the specific notification information is received from the server. The computer-readable instructions, when executed by the processor, may cause the server to, after the specific account information, the notification identification information, the device identification information and the specific notification information have been stored in association with each other in the memory and under a second login state where a second terminal device different from the first terminal device is logged in to the server using the specific account information, receive, from the second terminal device, a second request signal requesting sending of notification information associated with the specific account information. The computer-readable instructions, when executed by the processor, may cause the server to, in a case where the second request signal is received from the second terminal device, send the second terminal device the specific notification information associated with the specific account information. The second terminal device may display the specific notification information in a case where the specific notification information is received from the server.

According to the above configuration, the server sends the specific notification information to the first and second terminal devices which use the specific account information. The first and second terminal devices then display the specific notification information. Thus, user convenience pertaining to notification information is improved.

The disclosure herein also discloses a non-transitory computer-readable recording medium storing computer-readable instructions for a terminal device. The computer-readable instructions, when executed by a processor of the terminal device, may cause the terminal device to, under a first login state where a first terminal device is logged in to a server using specific account information, send the server a first generation request including notification identification information for identifying specific notification information and device identification information for identifying a specific communication device. The specific notification information may be for notifying a user of the specific communication device of existence of a service for the specific communication device. In a case where the first generation request is received from the terminal device, the server may generate the specific notification information corresponding to the notification identification information and store the specific account information, the notification identification information, the device identification information and the specific notification information in association with each other in a memory. The computer-readable instructions, when executed by the processor, may cause the terminal device to, after the first generation request has been sent to the server, send the server a first request signal requesting sending of notification information associated with the specific account information. The computer-readable instructions, when executed by the processor, may cause the terminal device to, after the first request signal has been sent to the server, receive, from the server, the specific notification information associated with the specific account information in the server. The computer-readable instructions, when executed by the processor, may cause the terminal device to, in a case where the specific notification information is received from the server, display the specific notification information on a display of the terminal device.

According to the above configuration, the terminal device receives, from the server, the specific notification information associated with the specific account information in the server and then displays the specific notification information. Thus, user convenience pertaining to notification information is improved.

The disclosure herein also discloses a communication system. The communication system may comprise a controller. The controller may be configured to, under a first login state where a first terminal device is logged in to a server using specific account information, receive a first generation request from the first terminal device. The first generation request may include notification identification information for identifying specific notification information and device identification information for identifying a specific communication device. The specific notification information may be for notifying a user of the specific communication device of existence of a service for the specific communication device. The controller may be configured to, in a case where the first generation request is received, generate the specific notification information corresponding to the notification identification information. The controller may be configured to, after the specific notification information has been generated, store the specific account information, the notification identification information, the device identification information and the specific notification information in association with each other in a memory. The controller may be configured to, after the specific notification information has been generated, receive, from the first terminal device, a first request signal requesting sending of notification information associated with the specific account information. The controller may be configured to, in a case where the first request signal is received from the first terminal device, send the first terminal device the specific notification information associated with the specific account information. The controller may be configured to, in a case where the specific notification information is received from the server, display on a display of the first terminal device the specific notification information. The controller may be configured to, after the specific account information, the notification identification information, the device identification information and the specific notification information have been stored in association with each other in the memory and under a second login state where a second terminal device different from the first terminal device is logged in to the server using the specific account information, receive, from the second terminal device, a second request signal requesting sending of notification information associated with the specific account information. The controller may be configured to, in a case where the second request signal is received from the second terminal device, send the second terminal device the specific notification information associated with the specific account information. The controller may be configured to, in a case where the specific notification information is received from the server, display on a display of the second terminal device the specific notification information.

According to the above configuration, the specific notification information is sent to the first and second terminal devices which use the specific account information. The first and second terminal devices then display the specific notification information. Thus, user convenience pertaining to notification information is improved.

Servers implemented by the above computer-readable instructions and methods of controlling the servers are also novel and useful. Further, methods of causing the terminal device to display screens are also novel and useful. Moreover, terminal devices implemented by the above computer-readable instructions and methods of controlling the terminal devices are also novel and useful. Additionally, a communication system comprising the server, first terminal device, and second terminal device is also novel and useful. Here, each of the non-transitory computer-readable recording media described above may be a single medium or a combination of multiple media.

### BRIEF DESCRIPTION OF DRAWINGS

FIG. 1 is a diagram illustrating a configuration of a communication system.

FIG. 2 is a diagram illustrating a management table and a user table.

FIG. 3 is a diagram illustrating a first local table and a second local table.

FIG. 4 is a flowchart of a merge process executed by a notification server.

FIG. 5 is a sequence diagram for Case A.

FIG. 6 is a diagram illustrating a continuation from FIG. 5.

FIG. 7 is a diagram illustrating screens displayed at a mobile terminal in Case A.

FIG. 8 is a diagram illustrating screens displayed at a PC in Case A.

FIG. 9 is a diagram illustrating a transition of the user table in Case A.

FIG. 10 is a diagram illustrating a transition of the first local table in Case A.

FIG. 11 is a diagram illustrating a transition of the second local table in Case A.

FIG. 12 is a sequence diagram for Case B.

FIG. 13 is a diagram illustrating a continuation from FIG. 12.

FIG. 14 is a diagram illustrating a transition of the user table in Case B.

FIG. 15 is a diagram illustrating a transition of the first local table in Case B.

FIG. 16 is a diagram illustrating a continuation from FIG. 15.

### DESCRIPTION

### Embodiments

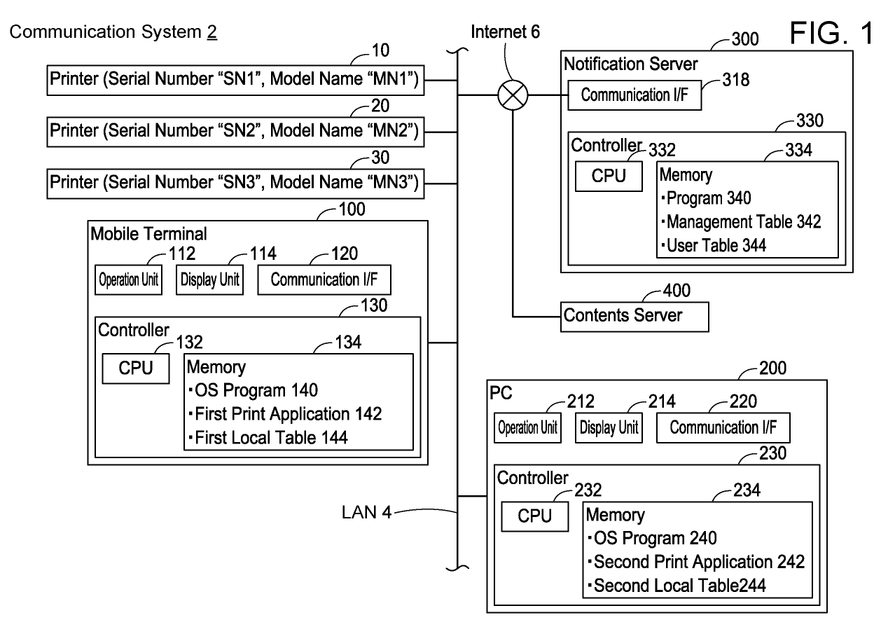

### Configuration of Communication System 2: FIG. 1

As illustrated in FIG. 1, a communication system 2 comprises a plurality of printers 10, 20, 30, a mobile terminal 100, a personal computer (PC) 200, a notification server 300, and a contents server 400.

The printers 10, 20, 30, the mobile terminal 100, and the PC 200 are connected to a local area network (LAN) 4. The printers 10, 20, 30, the mobile terminal 100, and the PC 200 are communicable with each other via the LAN 4. The notification server 300 and the contents server 400 are connected to the internet 6. Thus, the printers 10, 20, 30, the mobile terminal 100, the PC 200, the notification server 300, and the contents server 400 are communicable with each other via the internet 6.

### Configurations of Printers 10, 20, 30

The printers 10, 20, 30 are peripheral devices capable of executing a print function. The printers 10, 20, 30 are peripheral devices of, for example, the PC 200. The printers 10, 20, 30 each comprise a print mechanism capable of executing the print function. The print mechanism includes a print engine of inkjet scheme, electrophotographic scheme, or thermal scheme. A print engine of inkjet scheme comprises a print head configured to eject drops of ink. A print engine of electrophotographic scheme comprises a photoreceptor and an exposure device configured to emit light to expose the photoreceptor to the light. A print engine of thermal scheme comprises a print head configured to emit heat from a heater.

The printer 10 has a serial number “SN1” and a model name “MN1”. Serial numbers are identification numbers assigned to individual printers during manufacture of the printers. Model names indicate models of printers. The printer 20 has a serial number “SN2” and a model name “MN2”. The printer 30 has a serial number “SN3” and a model name “MN3”.

### Configuration of Mobile Terminal 100

The mobile terminal 100 is a portable terminal such as a mobile phone, a PDA, or a tablet PC. The mobile phone is a smartphone, although this is merely an example. The mobile terminal 100 comprises an operation unit 112, a display unit 114, a communication interface 120, and a controller 130. Hereinafter, an interface is abbreviated as “I/F”.

The operation unit 112 is a user interface through which users can input various information to the mobile terminal 100. The operation unit 112 comprises, for example, a touch screen for displaying software keys, hardware keys, or both of these. The software keys are operation objects. The hardware keys include, for example, buttons or switches. The display unit 114 is a display or a panel for displaying various information. The panel may be or may not be a touch panel. The panel is, for example, a liquid crystal panel or an organic EL panel. The communication I/F 120 is connected to the LAN 4.

The controller 130 comprises a CPU 132 and a memory 134. The memory 134 comprises a main storage and an auxiliary storage. The main storage includes a RAM and a cache memory, although this is merely an example. The auxiliary storage may be a ROM, a flash memory, a solid state drive (SSD), a hard disk drive (HDD), or any combination thereof, although this is merely an example. An operating system (OS) program 140, a first print application 142, and a first local table 144 are stored in the auxiliary storage of the memory 134. Application is an abbreviation of application program. Hereinafter, the OS program is abbreviated as “OS”. The OS 140 controls basic operations of the mobile terminal 100. The first print application 142 is a program for causing the printers to execute the print function. The first print application 142 is an application for mobile devices. The CPU 132 executes various processes according to programs loaded from the auxiliary storage to the main storage. Hereinafter, steps the CPU 132 executes according to the programs may be described as if the OS 140 or the first print application 142 executed the steps.

### Configuration of PC 200

The PC 200 is a stationary terminal device such as a desktop PC. In a modification, the PC 200 may be a mobile terminal device such as a tablet terminal or a laptop PC. The PC 200 comprises an operation unit 212, a display unit 214, a communication I/F 220, and a controller 230.

The operation unit 212 is a user interface through which users can input various information to the PC 200. The display unit 214 is a display or a panel for displaying various information. The operation unit 212 and the display unit 214 are similar to the operation unit 112 and the display unit 114 of the mobile terminal 100. The communication I/F 220 is connected to the LAN 4.

The controller 230 comprises a CPU 232 and a memory 234. The memory 234 is similar to the memory 134 of the mobile terminal 100. An OS 240, a second print application 242, and a second local table 244 are stored in the auxiliary storage of the memory 234. The OS 240 controls basic operations of the PC 200. The second print application 242 is a program for causing the printers to execute the print function. The second print application 242 is an application for PCs. The CPU 232 executes various processes according to programs loaded from the auxiliary storage to the main storage. Hereinafter, steps the CPU 232 executes according to the programs may be described as if the OS 240 or the second print application 242 executed the steps.

### Configuration of Notification Server 300

The notification server 300 is established on the internet 6 by a vendor different from the vendor of the printers 10, 20, 30. Hereinafter, the vendor of the printers 10, 20, 30 is simply termed “the vendor”. The notification server 300 may be a single server or a combination of multiple servers.

The notification server 300 manages notification information corresponding to services for printers. The services include, for example, an automatic shipping service, a subscription service, and a remote print service. The automatic shipping service is a service of automatically shipping a new cartridge when the remaining amount of ink in a cartridge mounted in a printer reaches a predetermined amount or less. The subscription service is a service of allowing service users to use print sheets within a predetermined period up to the number of print sheets available under contract at a base fee. The subscription service includes the automatic shipping service. The remote print service is a service of remotely causing a printer to execute its print function via the internet 6.

The notification server 300 comprises a communication I/F 318 and a controller 330. The communication I/F 318 is connected to the internet 6. The controller 330 comprises a CPU 332 and a memory 334. The memory 334 is similar to the memory 134 of the mobile terminal 100. A program 340, a management table 342, and a user table 344 are stored in the auxiliary storage of the memory 334. The CPU 332 executes various processes according to programs loaded from the auxiliary storage to the main storage.

In this embodiment, the same user uses both the mobile terminal 100 and the PC 200. In a modification, a user of the mobile terminal 100 may be different from a user of the PC 200.

### Configuration of Contents Server 400

The contents server 400 is established on the internet 6 by the vendor. The contents server 400 may be a single server or a combination of multiple servers. The contents server 400 stores image data each representing an information image and sends corresponding image data to an external device according to an instruction from the external device.

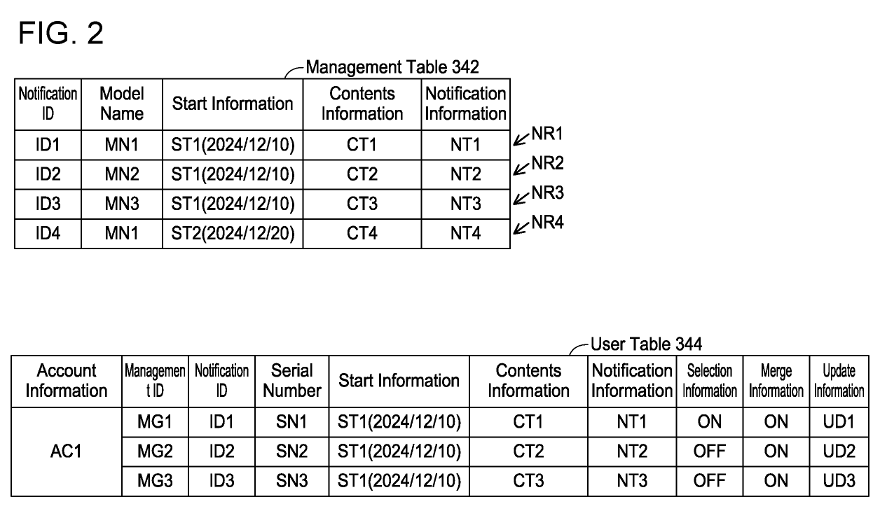

### Management Table 342 and User Table 344: FIG. 2

Referring to FIG. 2, the management table 342 and the user table 344 in the notification server 300 are described.

The management table 342 is a table for managing information for all users. In the management table 342, notification IDs, model names, start information, contents information, and notification information are stored in association with each other. The notification information is information for notifying users of printers of existence of services for the printers. Each notification information includes, for example, information indicative of a title and information indicative of a message. Each notification ID is information for identifying the notification information associated therewith. Each start information indicates a date on which the notification information associated therewith starts to be sent. Each contents information indicates a uniform resource locator (URL) to be accessed in case the notification information associated therewith is selected. Hereinafter, a set of a notification ID, a model name, start information, contents information, and notification information may be termed “notification-related information”. Each notification-related information is not associated with any account information. Each notification-related information is registered by the administrator of the notification server 300. In a modification, each notification-related information may be registered in the management table 342 by the notification server 300 receiving the notification-related information from a server different from the notification server 300.

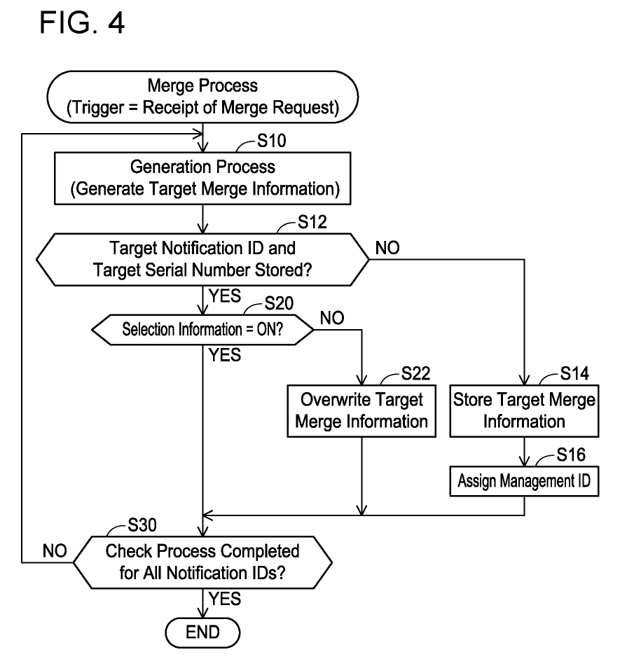

The user table 344 is a table for managing information for individual users. In the user table 344, account information, management IDs, notification IDs, serial numbers, start information, contents information, notification information, selection information, merge information, and update information are stored in association with each other. The management IDs are information for identifying information in the user table. The management IDs are generated by the notification server 300. Each selection information selectively indicates either “ON” which means that the notification information associated therewith has been selected or “OFF” which means that the notification information associated therewith has not been selected yet. Each merge information selectively indicates either “ON” which means that a merge process (which will be described referring to FIG. 4) has been executed or “OFF” which means that the merge process has not been executed yet. Each update information indicates a date and time at which information including the update information was stored or a date and time at which information including the update information was updated. Hereinafter, a set of a management ID, a notification ID, a serial number, start information, contents information, notification information, selection information, and merge information may be termed “user notification information”.

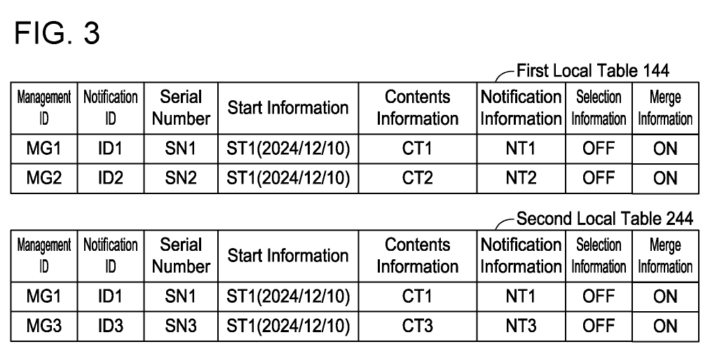

### First Local Table 144 and Second Local Table 244: FIG. 3

Referring to FIG. 3, the first local table 144 in the mobile terminal 100 and the second local table 244 in the PC 200 are described.

The first local table 144 in the mobile terminal 100 is a table for managing user notification information for the user of the mobile terminal 100. In the first local table 144, management IDs, notification IDs, serial numbers, start information, contents information, notification information, selection information, and merge information are stored in association with each other.

The second local table 244 in the PC 200 is a table for managing user notification information for the user of the PC 200. In the second local table 244, management IDs, notification IDs, serial numbers, start information, contents information, notification information, selection information, and merge information are stored in association with each other.

### Merge Process: FIG. 4

Referring to FIG. 4, a merge process executed by the CPU 332 of the notification server 300 is described. The CPU 332 starts the process of FIG. 4 in response to receiving a merge request from an external device. The merge request is a signal that requests the user table 344 to be updated using information included in the merge request. The merge request includes one or more notification IDs, one or more serial numbers, and selection information. Before receiving the merge request from the external device, the CPU 332 has already received account information from the external device. Hereinafter, this received account information is termed “the target account information”.

In S10, the CPU 332 generates target merge information using the received merge request and the management table 342 (i.e., a generation process). The CPU 332 specifies one notification ID as a target notification ID from among the one or more notification IDs included in the merge request. Hereinafter, the serial number and selection information associated with the target notification ID in the merge request may be termed “the target serial number” and “the target selection information”, respectively. The CPU 332 specifies the start information, contents information, and notification information associated with the target notification ID in the management table 342. Then, the CPU 332 generates target merge information including the target notification ID, the target serial number, the target selection information, the specified start information, the specified contents information, and the specified notification information. Thus, the notification server 300 extracts the notification information from the management table 342 in the memory 334 to generate the target merge information. This configuration allows for a reduction in time required to generate the target merge information compared to a configuration where notification information is newly generated.

In S12, the CPU 332 determines whether the combination of the target notification ID and the target serial number is already stored in association with the target account information in the user table 344. The CPU 332 proceeds to S20 in response to determining that the combination is already stored in the user table 344 (YES in S12). In contrast, the CPU 332 proceeds to S14 in response to determining that the combination is not stored yet in the user table 344 (NO in S12).

In S14, the CPU 332 stores the target merge information and merge information “ON” in association with the target account information in the user table 344. Further, the CPU 332 stores the current date and time as update information in association with the target merge information in the user table 344.

In S16, the CPU 332 generates a management ID and stores the generated management ID in association with the target merge information in the user table 344.

In addition, in S20, the CPU 332 determines whether the selection information associated with the target notification ID and the target serial number in the user table 344 indicates “ON”. The CPU 332 proceeds to S22 in response to determining that the selection information does not indicate “ON” (NO in S20). In contrast, the CPU 332 proceeds to S30 in response to determining that the selection information indicates “ON” (YES in S20). In case the determination of YES is made in S20, the CPU 332 updates the update information associated with the target notification ID to the current date and time in the user table 344.

In S22, the CPU 332 overwrites information in the user table 344 with the target merge information. Further, the CPU 332 updates update information using the current date and time.

In S30, the CPU 332 determines whether a check process (S10 to S22) has been completed for all of the one or more notification IDs included in the merge request. The CPU 332 ends the process of FIG. 4 in response to determining that the check process has been completed for all of the one or more notification IDs (YES in S30). In contrast, the CPU 332 returns to S10 in response to determining that the check process has not been completed for at least one of the one or more notification IDs (NO in S30).

### Specific Cases

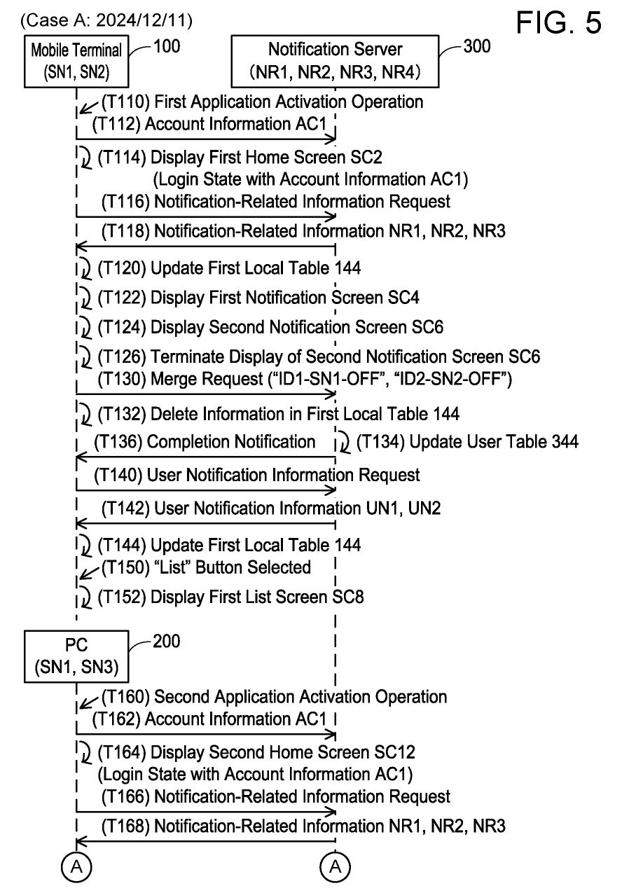

Referring to FIGS. 5 to 16, specific cases implemented by the communication system 2 according to this embodiment are described.

### Case A: FIGS. 5 to 11

Referring to FIGS. 5 to 11, Case A is described. In the initial state of Case A, the printers 10, 20 have been already registered in the first print application 142 in the mobile terminal 100. Thus, the serial numbers “SN1”, “SN2” and the model names “MN1”, “MN2” have been already stored in the memory 134 of the mobile terminal 100. Further, in the initial state, the printers 10, 30 have been already registered in the second print application 242 in the PC 200. Thus, the serial numbers “SN1”, “SN3” and the model names “MN1”, “MN3” have been already stored in the memory 234 of the PC 200. Moreover, in the initial state of Case A, the contents of the management table 342 are the same as the contents of the management table 342 illustrated in FIG. 2. That is, in the management table 342, notification-related information NR1, NR2, NR3, NR4 are stored. Start information ST1 and ST2 indicate “2024/12/10” and “2024/12/20”, respectively. Additionally, in the initial state, the first local table 144, the second local table 244, and the user table 344 are all blank. The date on which Case A takes place is December 11, 2024 (2024/12/11). Further, the mobile terminal 100 logged in to the notification server 300 with account information AC1 when the first print application 142 was activated previously. Also, the PC 200 logged in to the notification server 300 with the account information AC1 when the second print application 242 was activated previously. Hereinafter, to facilitate the understanding, steps executed by the CPUs of devices are described as if the devices executed the steps. Further, since the devices communicate with each other via their communication I/Fs, a phrase “via the communication I/F” is omitted for descriptions on communication in the following description.

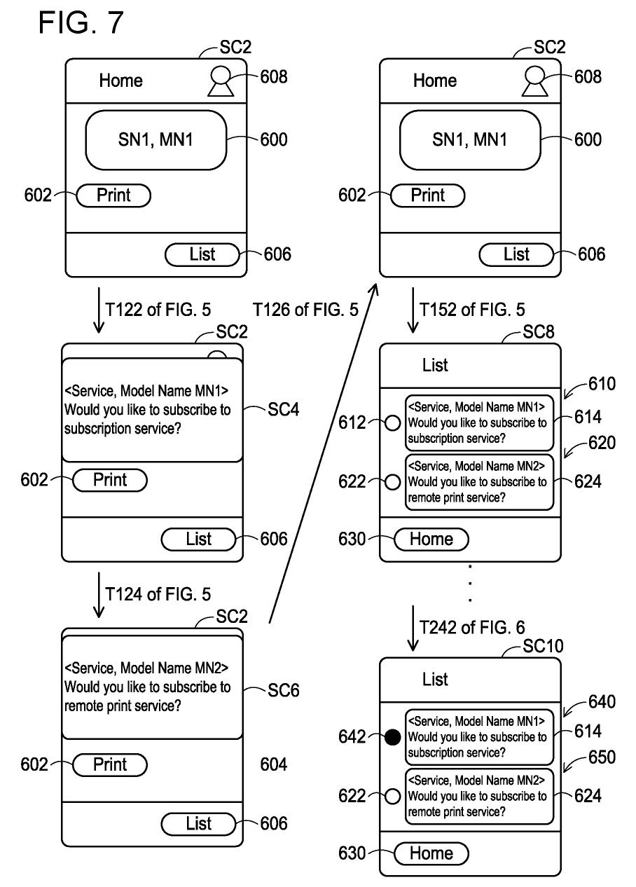

In T110, the user of the mobile terminal 100 performs on the mobile terminal 100 a first application activation operation which is an operation to activate the first print application 142. In response, the mobile terminal 100 activates the first print application 142 and determines that the mobile terminal 100 logged in to the notification server 300 with the account information AC1 when the first print application 142 was activated previously. In this case, the mobile terminal 100 sends the account information AC1 to the notification server 300 and receives a login success notification from the notification server 300 in T112. Thus, the state of the mobile terminal 100 shifts to a state of being logged in to the notification server 300 with the account information AC1. In T114, the mobile terminal 100 displays a first home screen SC2 on the display unit 114. As illustrated in FIG. 7, the first home screen SC2 includes a device object 600, a “print” button 602, a “list” button 606, and a login icon 608. The device object 600 displays information about a device selected as a destination of instruction information, such as a print instruction, among one or more devices registered in the first print application 142. In the present case, the device object 600 displays the serial number “SN1” and the model name “MN1”. In case no devices have been registered in the first print application 142 yet, the device object 600 displays a character string “Not Selected”. The “list” button 606 is a button for displaying a list screen at the mobile terminal 100. The login icon 608 is an icon for a login with account information. The login icon 608 is also an icon for a logout.

In T116 of FIG. 5, the mobile terminal 100 sends a notification-related information request to the notification server 300. The notification-related information request is a signal that requests the notification server 300 to send notification-related information.

In response to receiving the notification-related information request from the mobile terminal 100 in T116, the notification server 300 specifies notification-related information to be sent to the mobile terminal 100. The notification server 300 first specifies the notification-related information NR1, NR2, NR3 including the start information ST1 which indicates a date before the date of today in the management table 342. The notification server 300 then determines that the specified notification-related information NR1, NR2, NR3 have not been sent yet to the logged-in mobile terminal 100. In this case, the notification server 300 specifies the notification-related information NR1, NR2, NR3 as notification-related information to be sent to the mobile terminal 100. In T118, the notification server 300 sends the notification-related information NR1, NR2, NR3 to the mobile terminal 100. Further, the notification server 300 stores in the memory 334 that the notification-related information NR1, NR2, NR3 have been sent to the logged-in mobile terminal 100.

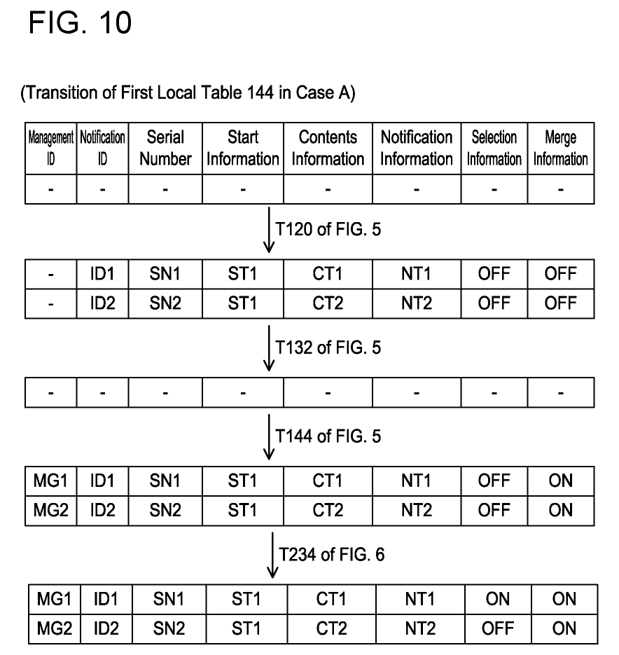

In response to receiving the notification-related information NR1, NR2, NR3 from the notification server 300 in T118, the mobile terminal 100 specifies notification-related information to be displayed on notification screens. Specifically, the mobile terminal 100 specifies the notification-related information NR1, NR2 each including the model name “MN1” or “MN2” stored in the memory 134 as the notification-related information to be displayed. Then, the mobile terminal 100 updates the first local table 144 using the specified notification-related information NR1, NR2 in T120. Specifically, the mobile terminal 100 first specifies the serial number “SN1” corresponding to the model name “MN1” included in the notification-related information NR1. Then, as illustrated in FIG. 10, the mobile terminal 100 stores the notification-related information NR1, excluding the model name “MN1”, in the first local table 144. The mobile terminal 100 further stores the serial number “SN1”, the selection information “OFF”, and the merge information “OFF” in the first local table 144. As a result, a notification ID “ID1”, the serial number “SN1”, the start information ST1, contents information CT1, notification information NT1, the selection information “OFF”, and the merge information “OFF” are stored in association with each other in the first local table 144. The mobile terminal 100 also executes the same update process for the notification-related information NR2. As a result, a notification ID “ID2”, the serial number “SN2”, the start information ST1, contents information CT2, notification information NT2, the selection information “OFF”, and the merge information “OFF” are stored in association with each other in the first local table 144.

In T122 of FIG. 5, the mobile terminal 100 displays a first notification screen SC4 over the first home screen SC2, using the notification information NT1 in the notification-related information NR1. As illustrated in FIG. 7, the first notification screen SC4 is displayed in a pop-up manner over the first home screen SC2. The first notification screen SC4 includes a message corresponding to the notification information NT1. This message is related to the subscription service. In response to a predetermined period elapsing without the first notification screen SC4 being selected, the mobile terminal 100 displays a second notification screen SC6 over the first home screen SC2 in T124 of FIG. 5. The predetermined period is seven seconds, although this is merely an example. As illustrated in FIG. 7, the second notification screen SC6 is displayed in a pop-up manner over the first home screen SC2. The second notification screen SC6 includes a message corresponding to the notification information NT2. This message is related to the remote print service. In response to the predetermined period elapsing without the second notification screen SC6 being selected, the mobile terminal 100 terminates the display of the second notification screen SC6 in T126 of FIG. 5.

Then, the mobile terminal 100 specifies information to be included in a merge request to be sent to the notification server 300. Specifically, the mobile terminal 100 specifies the notification IDs, serial numbers, and selection information that are associated with the merge information “OFF” in the first local table 144. The mobile terminal 100 then sends the notification server 300 a merge request including “ID1-SN1-OFF” and “ID2-SN2-OFF” in T130. The mobile terminal 100 deletes the information in the first local table 144 in T132.

In response to receiving the merge request from the mobile terminal 100 in T130, the notification server 300 executes the merge process (see FIG. 4) to update the user table 344 in T134. The notification server 300 first specifies the notification ID “ID1” as the target notification ID from among the notification IDs “ID1”, “ID2” included in the merge request. The notification server 300 then executes the generation process to generate target merge information including the notification ID “ID1”, the serial number “SN1”, the start information ST1, the contents information CT1, the notification information NT1, and the selection information “OFF” (S10). Then, the notification server 300 determines that the combination of the notification ID “ID1” and the serial number “SN1” has not been stored yet in association with the account information AC1 in the user table 344 (NO in S12). In this case, the notification server 300 stores the target merge information in association with the account information AC1 in the user table 344 (S14). The notification server 300 further stores update information indicative of the current date and time in association with the target merge information in the user table 344 (S14). The notification server 300 then stores a management ID “MG1” in association with the target merge information in the user table 344 (S16). As a result, user notification information UN1 is generated.

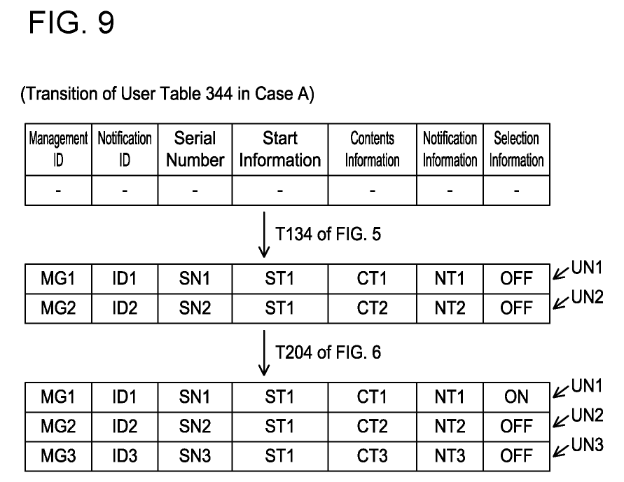

The notification server 300 determines that the check process has not been completed for the notification ID “ID2” (NO in S30). The notification server 300 executes the same steps executed for the notification ID “ID1” to the notification ID “ID2” (S10, NO in S12, S14, S16). As a result, user notification information UN2 is stored in the user table 344 as illustrated in FIG. 9. The notification server 300 then determines that the check process has been completed for all the notification IDs included in the merge request (YES in S30) and sends the mobile terminal 100 a completion notification indicating that the merge process has been completed in T136 of FIG. 5.

In response to receiving the completion notification from the notification server 300 in T136, the mobile terminal 100 sends a user notification information request to the notification server 300 in T140. The user notification information request is a signal that requests the notification server 300 to send the user notification information associated with the account information used for the login. While the mobile terminal 100 is in the login state (i.e., the state of being logged in to the notification server 300), the mobile terminal 100 periodically sends a user notification information request to the notification server 300.

In response to receiving the user notification information request from the mobile terminal 100 in T140, the notification server 300 specifies the user notification information UN1, UN2 associated with the account information AC1. The notification server 300 adjusts data positions of these user notification information according to the date and times indicated by the update information associated therewith. The notification server 300 sends the user notification information UN1, UN2 to the mobile terminal 100 in T142.

In response to receiving the user notification information UN1, UN2 from the notification server 300 in T142, the mobile terminal 100 updates the first local table 144 using these information in T144. As illustrated in FIG. 10, the mobile terminal 100 stores the user notification information UN1, UN2 in the first local table 144 and also stores the merge information “ON” in association with the user notification information UN1, UN2 in the first local table 144.

In T150 of FIG. 5, the user operates the “list” button 606 in the first home screen SC2. In response, the mobile terminal 100 displays a first list screen SC8 on the display unit 114 using the first local table 144 in T152. As illustrated in FIG. 7, the first list screen SC8 includes a first notification region 610, a second notification region 620, and a “home” button 630. The first notification region 610 corresponds to the user notification information UN1. The first notification region 610 includes an unselected object 612 and a message region 614. The unselected object 612 is an object indicative that notification information has not been selected yet. In this embodiment, the unselected object is a white circle. Here, “notification information has not been selected yet” can mean that the user has not read the notification information yet. The message region 614 displays the information indicated by the notification information NT1. The second notification region 620 corresponds to the user notification information UN2. The second notification region 620 includes an unselected object 622 and a message region 624. The message region 624 displays the information indicated by the notification information NT2. Thus, the user of the mobile terminal 100 can check the notification information for the printers 10, 20 by operating the “list” button 606.

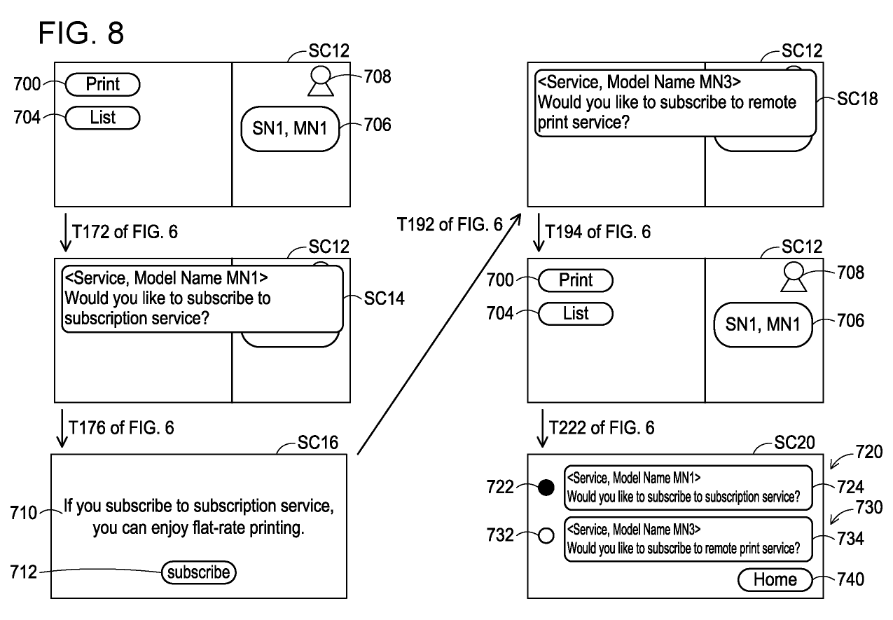

Below is on the assumption that the user uses the PC 200. The user performs on the PC 200 a second application activation operation to activate the second print application 242 in T160. In response, the PC 200 activates the second print application 242 and determines that the PC 200 logged in to the notification server 300 with the account information AC1 when the second print application 242 was activated previously. In this case, the PC 200 sends the account information AC1 to the notification server 300 and receives a login success notification from the notification server 300 in T162. Thus, the PC 200 shifts to the login state. In T164, the PC 200 displays a second home screen SC12 on the display unit 214. As illustrated in FIG. 8, the second home screen SC12 includes a “print” button 700, a “list” button 704, a device object 706, and a login icon 708. The device object 706 displays information about a device selected as a destination of instruction information, such as a print instruction, among one or more devices registered in the second print application 242. In the present case, the device object 706 displays the serial number “SN1” and the model name “MN1”. In case no devices have been registered yet in the second print application 242, the device object 706 displays a character string “Not Selected”. The “list” button 704 is a button for displaying a list screen at the PC 200. The login icon 708 is an icon for a login with account information. The login icon 708 is also an icon for a logout. The PC 200 sends a notification-related information request to the notification server 300 in T166 of FIG. 5.

In response to receiving the notification-related information request from the PC 200 in T166, the notification server 300 specifies the notification-related information NR1, NR2, NR3 as notification-related information to be sent to the PC 200. In T168, the notification server 300 sends the notification-related information NR1, NR2, NR3 to the PC 200. The notification server 300 stores in the memory 334 that the notification-related information NR1, NR2, NR3 have been sent to the logged-in PC 200.

In response to receiving the notification-related information NR1, NR2, NR3 from the notification server 300 in T168, the PC 200 specifies notification-related information to be displayed on notification screens. Specifically, the PC 200 specifies the notification-related information NR1, NR3 each including the model name “MN1” or “MN3” stored in the memory 234 as notification-related information to be displayed.

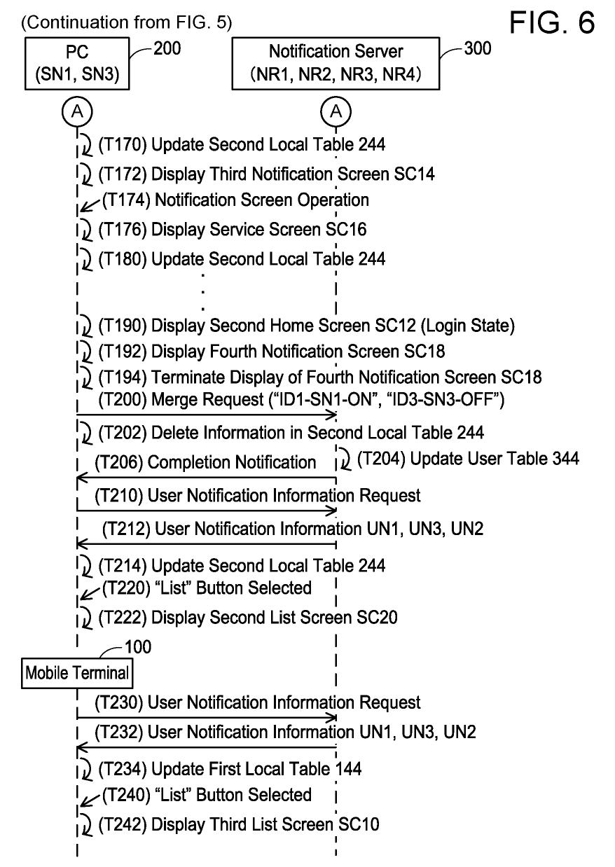

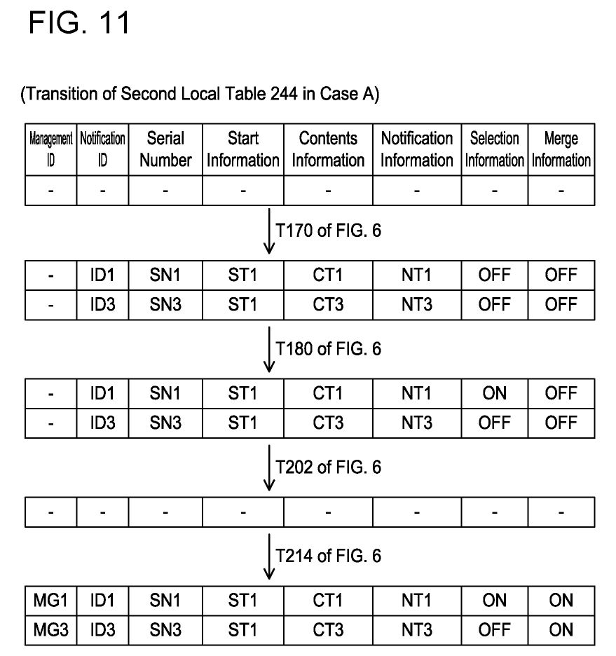

In T170 of FIG. 6, the PC 200 updates the second local table 244 using the specified notification-related information NR1, NR3. The PC 200 updates the second local table 244 in T170 in the same way as the first local table 144 was updated in T120. Thus, as illustrated in FIG. 11, the notification ID “ID1”, the serial number “SN1”, the start information ST1, the contents information CT1, the notification information NT1, the selection information “OFF”, and the merge information “OFF” are stored in association with each other in the second local table 244. Further, a notification ID “ID3”, the serial number “SN3”, the start information ST1, contents information CT3, notification information NT3, the selection information “OFF”, and the merge information “OFF” are stored in association with each other in the second local table 244.

In T172 of FIG. 6, the PC 200 displays a third notification screen SC14 over the second home screen SC12, using the notification information NT1 in the notification-related information NR1. As illustrated in FIG. 8, the third notification screen SC14 is displayed in a pop-up manner over the second home screen SC12. The third notification screen SC14 includes a message corresponding to the notification information NT1.

In T174 of FIG. 6, the user selects the third notification screen SC14. In response, the PC 200 uses the URL indicated by the contents information CT1 in the notification-related information NR1 to access the contents server 400. The PC 200 receives first service screen data representing a first service screen SC16 from the contents server 400 and displays the first service screen SC16 on the display unit 214 in T176. As illustrated in FIG. 8, the first service screen SC16 includes a message 710 describing the subscription service and a “subscribe” button 712. In response to the user operating the “subscribe” button 712, a subscription process for subscription to the subscription service is executed. The subscription process is executed between the printer 10, the PC 200, and a server that provides the subscription service.

In T180 of FIG. 6, the PC 200 updates the second local table 244. As illustrated in FIG. 11, the PC 200 changes the selection information associated with the notification ID “ID1” corresponding to the third notification screen SC14 to “ON” in the second local table 244.

In T190, the second home screen SC12 is displayed on the display unit 214 of the PC 200. Then, the PC 200 displays a fourth notification screen SC18 over the second home screen SC12, using the notification information NT3 in the notification-related information NR3 in T192. As illustrated in FIG. 8, the fourth notification screen SC18 is displayed in a pop-up manner over the second home screen SC12. The fourth notification screen SC18 includes a message corresponding to the notification information NT3. This message is related to the remote print service. In response to the predetermined period elapsing without the fourth notification screen SC18 being selected, the PC 200 terminates the display of the fourth notification screen SC18 in T194 of FIG. 6.

Then, the PC 200 specifies information to be included in a merge request to be sent to the notification server 300. The PC 200 first specifies the notification IDs, serial numbers, and selection information that are associated with the merge information “OFF” in the second local table 244. The PC 200 then sends the notification server 300 a merge request including “ID1-SN1-ON” and “ID3-SN3-OFF” in T200. Further, the PC 200 deletes the information in the second local table 244 in T202.

In response to receiving the merge request from the PC 200 in T200, the notification server 300 executes the merge process (see FIG. 4) in T204 to update the user table 344. The notification server 300 first specifies the notification ID “ID1” as the target notification ID from among the notification IDs “ID1”, “ID3” included in the merge request and generates target merge information including the notification ID “ID1” (S10). The notification server 300 then determines that the combination of the notification ID “ID1” and the serial number “SN1” has been already stored in association with the account information AC1 in the user table 344 (YES in S12). Then, the notification server 300 determines that the selection information associated with the notification ID “ID1” and the serial number “SN1” indicates “OFF” in the user table 344 (NO in S20). In this case, the notification server 300 overwrites information in the user table 344 with the target merge information and updates the update information (S22). As a result, the selection information associated with the notification ID “ID1” and the serial number “SN1” changes to “ON”.

Then, the notification server 300 determines that the check process has not been completed for the notification ID “ID3” (NO in S30) and generates target merge information including the notification ID “ID3” (S10). The notification server 300 determines that the combination of the notification ID “ID3” and the serial number “SN3” has not been stored yet in association with the account information AC1 in the user table 344 (NO in S12). In this case, the notification server 300 stores the target merge information including the notification ID “ID3” in association with the account information AC1 in the user table 344 (S14). Further, the notification server 300 stores update information indicative of the current date and time in association with the target merge information in the user table 344 (S14). Then, the notification server 300 stores a management ID “MG3” in association with the target merge information in the user table 344 (S16). Thus, as illustrated in FIG. 9, the user notification information UN1 is updated and user notification information UN3 is stored in the user table 344. The notification server 300 then determines that the check process has been completed for all the notification IDs (YES in S30) and sends a completion notification to the PC 200 in T206 of FIG. 6.

In response to receiving the completion notification from the notification server 300 in T206, the PC 200 sends a user notification information request to the notification server 300 in T210. While the PC 200 is in the login state, the PC 200 periodically sends a user notification information request to the notification server 300.

In response to receiving the user notification information request from the PC 200 in T210, the notification server 300 sends the user notification information UN1, UN3, UN2 associated with the account information AC1 to the PC 200 in T212.

In response to receiving the user notification information UN1, UN3, UN2 from the notification server 300 in T212, the PC 200 updates the second local table 244 using these information in T214. The PC 200 first specifies the user notification information UN1, UN3 each including the serial number “SN1” or “SN3” stored in the memory 234 from among the received user notification information UN1, UN3, UN2. Then, as illustrated in FIG. 11, the PC 200 stores the user notification information UN1, UN3 in the second local table 244 and also stores the merge information “ON” in association with the user notification information UN1, UN3 in the second local table 244.

In T220 of FIG. 6, the user operates the “list” button 704 in the second home screen SC12. In response, the PC 200 displays a second list screen SC20 on the display unit 214 using the second local table 244 in T222. As illustrated in FIG. 8, the second list screen SC20 includes a third notification region 720, a fourth notification region 730, and a “home” button 740. The third notification region 720 corresponds to the user notification information UN1. The third notification region 720 includes a selected object 722 and a message region 724. The selected object 722 is an object indicative that notification information has been selected. In this embodiment, the selected object is a black circle. Here, “notification information has been selected” can mean that the user has already read the notification information. The message region 724 displays the information indicated by the notification information NT1. The fourth notification region 730 corresponds to the user notification information UN3. The fourth notification region 730 includes an unselected object 732 and a message region 734. The message region 734 displays the information indicated by the notification information NT3. As above, the user of the mobile terminal 100 can check the notification information for the printers 10, 30 by operating the “list” button 704.

As illustrated in the first list screen SC8 in FIG. 7, in case notification information has not been selected yet, the notification information is displayed in a display manner associated with the unselected object. In contrast, as illustrated in the second list screen SC20 in FIG. 8, in case notification information has been already selected, the notification information is displayed in a display manner associated with the selected object. Thus, in response to notification information being selected, the unselected object associated with the notification information is changed to the selected object. Therefore, the user is able to know whether notification information has been selected or not by seeing the display manner of the notification information. In a modification, in case notification information has not been selected yet, the notification region may be displayed in a display manner including only a message region, whereas in case notification information has been already selected, the notification region may be displayed in a display manner including a message region and a selected object. In this modification, in case notification information has not been selected yet, a screen background or a message region is displayed in the region where a selected object would be displayed if the notification information were already selected. In another modification, in case notification information has been already selected, the notification region may be displayed in a display manner including only the message region, whereas in case notification information has not been selected yet, the notification region may be displayed in a display manner including a message region and an unselected object. In this modification, in case notification information has been selected, a screen background or a message region is displayed in the region where an unselected object would be displayed if the notification information were not selected yet. In another modification, a display manner by which a message region is displayed in case notification information has not been selected yet may be different from a display manner by which a message region is displayed in case notification information has been already selected. In other words, notification information may be displayed in any display manner as long as it can be distinguished whether the notification information has been already selected or has not been selected yet.

Below is on the assumption that the user operates the “list” button 606 (see FIG. 7) in the first home screen SC2 after the mobile terminal 100 has sent a user notification information request to the notification server 300. In T230, the mobile terminal 100 sends a user notification information request to the notification server 300. Then, the mobile terminal 100 receives the user notification information UN1, UN3, UN2 from the notification server 300 in T232 and updates the first local table 144 using these information in T234. The mobile terminal 100 first specifies the user notification information UN1, UN2 each including the serial number “SN1” or “SN2” stored in the memory 134 from among the received user notification information UN1, UN3, UN2. Then, the mobile terminal 100 updates the user notification information UN1, UN2 in the first local table 144 using the specified user notification information UN1, UN2. As a result, as illustrated in FIG. 10, the selection information associated with the notification ID “ID1” changes to “ON” in the first local table 144.

In T240 of FIG. 6, the user operates the “list” button 606 in the first home screen SC2. In response, the mobile terminal 100 displays a third list screen SC10 on the display unit 114 using the first local table 144 in T242. As illustrated in FIG. 7, the third list screen SC10 includes a fifth notification region 640, a sixth notification region 650, and a “home” button 630. The fifth notification region 640 corresponds to the user notification information UN1. The fifth notification region 640 includes a selected object 642 and a message region 614. The fifth notification region 640 is different from the first notification region 610 in the first list screen SC8 in that the fifth notification region 640 includes the selected object 642. The sixth notification region 650 corresponds to the user notification information UN2. The sixth notification region 650 is the same as the second notification region 620 in the first list screen SC8. As above, in the third list screen SC10, the fifth notification region 640 corresponding to the notification information NT1 selected through the PC 200 includes the selected object 642. Thereby, the user is able to know that the notification information NT1 has been selected. Thus, user convenience is improved.

As described above, the notification server 300 receives merge requests from external devices which are logged in to the notification server 300 with specific account information. The notification server 300 then updates the user table 344 using the specific account information and the merge requests. In this configuration, when the different external devices, which communicate with the notification server 300, use the same account information to log in to the notification server 300, the notification server 300 updates the selection information associated with that account information. Thus, the notification server 300 can synchronize selection information for multiple external devices that use the same account information.

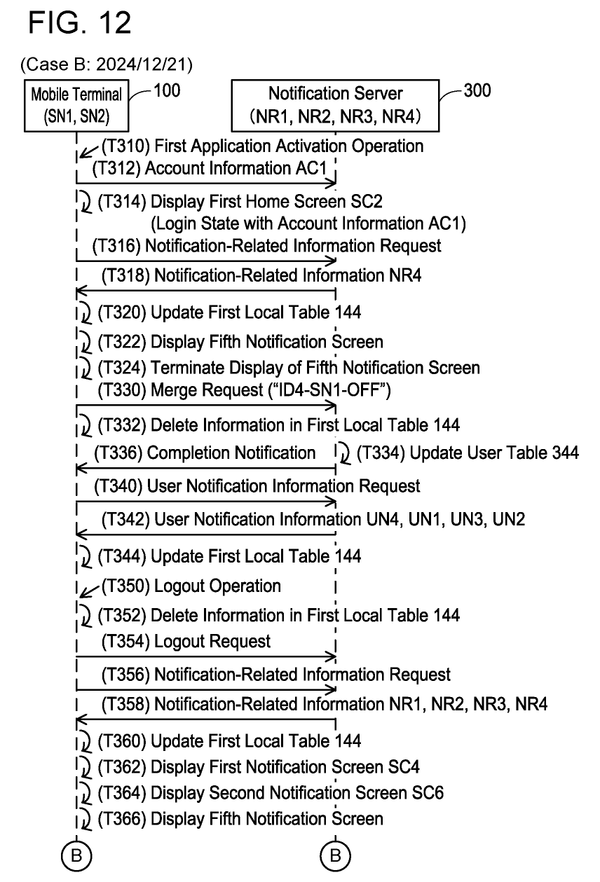

### Case B: FIGS. 12 to 16

Referring to FIGS. 12 to 16, Case B is described. Case B takes place after Case A. The date on which Case B takes place is December 21, 2024 (2024/12/21).

A sequence from T310 to T316 is the same as the sequence from T110 to T116 in FIG. 5. In response to receiving the notification-related information request from the mobile terminal 100 in T316, the notification server 300 specifies notification-related information to be sent to the mobile terminal 100. The notification server 300 first specifies the notification-related information NR1, NR2, NR3, NR4 including the start information ST1, ST2 indicative of dates before the date of today in the management table 342. The notification server 300 then determines that the notification-related information NR1, NR2, NR3 have been already sent to the logged-in mobile terminal 100 and the notification-related information NR4 has not been sent yet to the logged-in mobile terminal 100. In this case, the notification server 300 specifies the notification-related information NR4 as notification-related information to be sent to the mobile terminal 100. In T318, the notification server 300 sends the notification-related information NR4 to the mobile terminal 100. The notification server 300 stores in the memory 334 that the notification-related information NR4 has been sent to the logged-in mobile terminal 100.

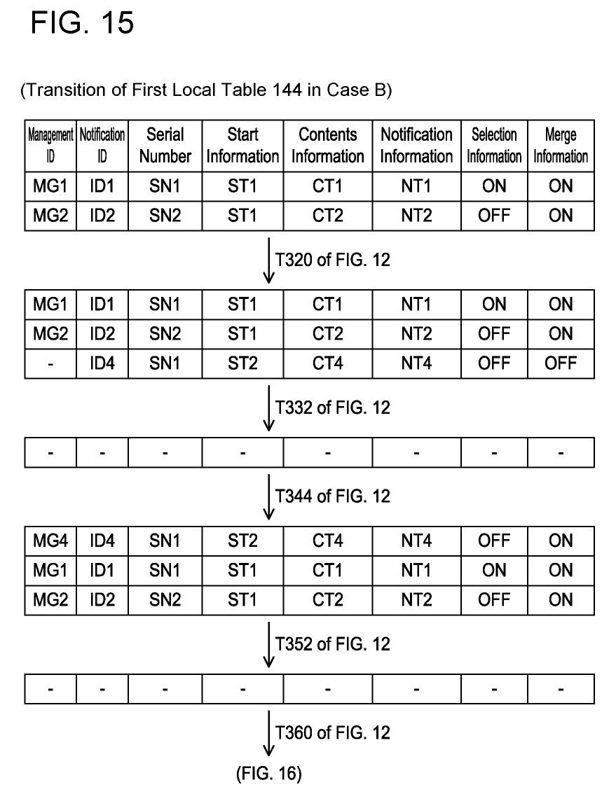

In response to receiving the notification-related information NR4 from the notification server 300 in T318, the mobile terminal 100 specifies the notification-related information NR4 as notification information to be displayed. The mobile terminal 100 then updates the first local table 144 using the specified notification-related information NR4 in T320. As a result, as illustrated in FIG. 15, a notification ID “ID4”, the serial number “SN1”, the start information ST2, contents information CT4, notification information NT4, the selection information “OFF”, and the merge information “OFF” are stored in association with each other in the first local table 144.

In T322 of FIG. 12, the mobile terminal 100 displays a fifth notification screen over the first home screen SC2, using the notification information NT4 in the notification-related information NR4. The fifth notification screen is displayed in a pop-up manner over the first home screen SC2. The fifth notification screen includes a message indicated by the notification information NT4. This message is related to the automatic shipping service. In response to the predetermined period elapsing without the fifth notification screen being selected, the mobile terminal 100 terminates the display of the fifth notification screen in T324.

The mobile terminal 100 specifies the notification ID “ID4”, the serial number “SN1”, and the selection information “OFF” associated with the merge information “OFF” in the first local table 144. Then, the mobile terminal 100 sends the notification server 300 a merge request including “ID4-SN1-OFF” in T330. Further, the mobile terminal 100 deletes the information in the first local table 144 in T332.

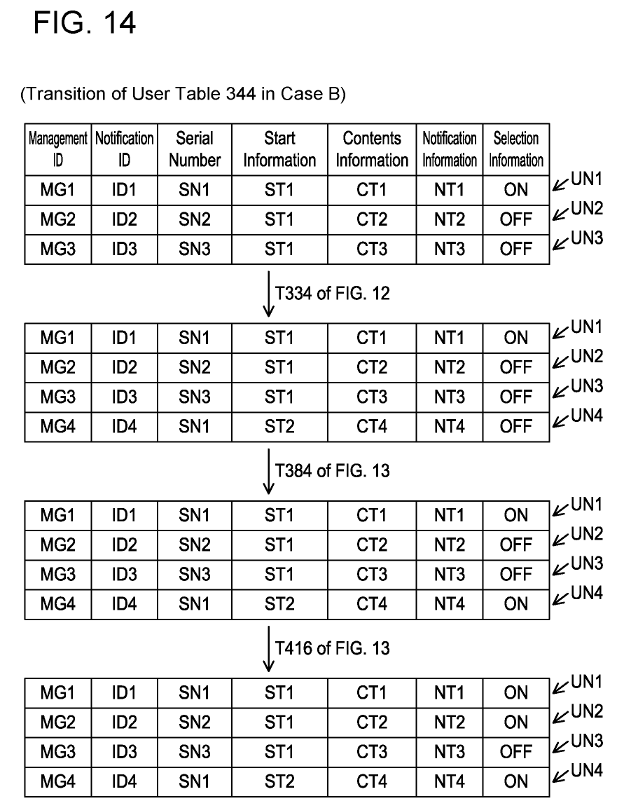

In response to receiving the merge request from the mobile terminal 100 in T330, the notification server 300 executes the merge process (see FIG. 4) in T334 to update the user table 344. The notification server 300 specifies the notification ID “ID4” included in the merge request as the target notification ID and generates target merge information including the notification ID “ID4” (S10). The notification server 300 determines that the combination of the notification ID “ID4” and the serial number “SN1” has not been stored yet in association with the account information AC1 in the user table 344 (NO in S12). In this case, the notification server 300 stores the target merge information in the user table 344 (S14). Further, the notification server 300 stores update information indicative of the current date and time in association with the target merge information in the user table 344 (S14). Then, the notification server 300 stores a management ID “MG4” in association with the target merge information in the user table 344 (S16). As a result, as illustrated in FIG. 14, user notification information UN4 is stored in the user table 344. Then, the notification server 300 determines that the check process has been completed for all the notification IDs (YES in S30) and sends a completion notification to the mobile terminal 100 in T336 of FIG. 12.

In response to receiving the completion notification from the notification server 300 in T336, the mobile terminal 100 sends a user notification information request to the notification server 300 in T340. The mobile terminal 100 receives the user notification information UN4, UN1, UN3, UN2 from the notification server 300 in T342. The mobile terminal 100 specifies the user notification information UN4, UN1, UN2 each including the serial number “SN1” or “SN2” stored in the memory 134 from among the received user notification information UN4, UN1, UN3, UN2. In T344, the mobile terminal 100 updates the first local table 144 using the specified user notification information UN4, UN1, UN2. As illustrated in FIG. 15, the mobile terminal 100 stores the user notification information UN4, UN1, UN2 in the first local table 144 and also stores the merge information “ON” in association with the user notification information UN4, UN1, UN2 in the first local table 144.

In T350 of FIG. 12, the user performs a logout operation. In response, the mobile terminal 100 deletes the information in the first local table 144 in T352. The mobile terminal 100 sends a logout request to the notification server 300 in T354. In response, the mobile terminal 100 shifts from the login state to a logout state. In T356, the mobile terminal 100 sends a notification-related information request to the notification server 300.

In response to receiving the notification-related information request from the mobile terminal 100 in T356, the notification server 300 specifies notification-related information to be sent to the logged-out mobile terminal 100. The notification server 300 specifies the notification-related information NR1, NR2, NR3, NR4 each including the start information ST1 or ST2 indicative of dates before the date of today in the management table 342. The notification server 300 sends the notification-related information NR1, NR2, NR3, NR4 to the mobile terminal 100 in T358. Thus, after the mobile terminal 100 has shifted from the login state to the logout state, the notification server 300 sends the mobile terminal 100 the notification-related information that was/were already sent to the mobile terminal 100 when it was in the login state. Thus, the notification server 300 can appropriately switch the notification-related information to be sent to the mobile terminal 100 depending on the state of the mobile terminal 100.

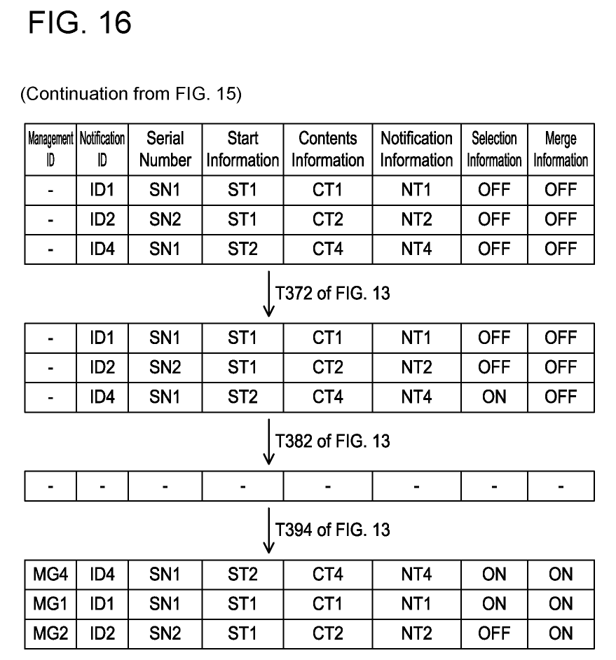

In response to receiving the notification-related information NR1, NR2, NR3, NR4 from the notification server 300 in T358, the mobile terminal 100 specifies notification-related information to be displayed on notification screens. The mobile terminal 100 specifies the notification-related information NR1, NR2, NR4 each including the model name “MN1” or “MN2” stored in the memory 134 as notification-related information to be displayed. Then, the mobile terminal 100 updates the first local table 144 using the specified notification-related information NR1, NR2, NR4. As a result, as illustrated in FIG. 16, information including the notification ID “ID1”, information including the notification ID “ID2”, and information including the notification ID “ID4” are stored in the first local table 144.

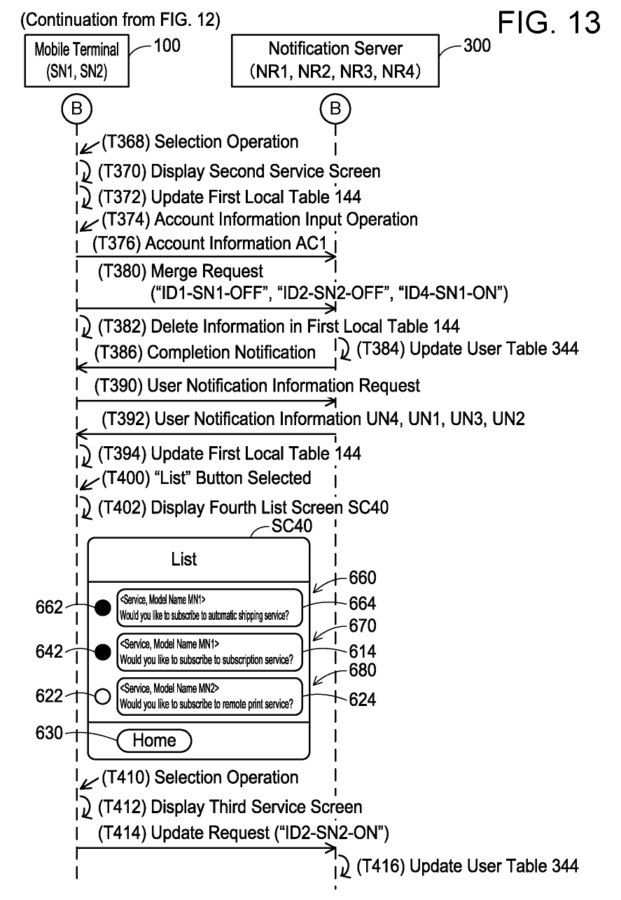

T362, T364, and T366 in FIG. 12 are the same as T122 in FIG. 5, T124 in FIG. 5, and T322 in FIG. 12, respectively. In T368 of FIG. 13, the user selects the fifth notification screen displayed at the mobile terminal 100. In response, the mobile terminal 100 uses the URL indicated by the contents information CT4 in the notification-related information NR4 to access the contents server 400. In response to receiving second service screen data representing a second service screen from the contents server 400, the mobile terminal 100 displays the second service screen on the display unit 114 in T370. The second service screen is related to the automatic shipping service.

The mobile terminal 100 updates the first local table 144 in T372. As illustrated in FIG. 16, the mobile terminal 100 changes the selection information associated with the notification ID “ID4” corresponding to the fifth notification screen to “ON” in the first local table 144.

Below is on the assumption that the first home screen SC2 is displayed on the display unit 114 of the mobile terminal 100. The user performs an account information input operation in T374. The account information input operation includes an operation on the login icon 608 and input of the account information AC1. The mobile terminal 100 sends the account information AC1 to the notification server 300 in T376 and receives a login success notification from the notification server 300. Thus, the mobile terminal 100 shifts from the logout state to the login state.

Then, the mobile terminal 100 specifies information to be included in a merge request to be sent to the notification server 300. The mobile terminal 100 specifies the notification IDs, serial numbers, and selection information associated with the merge information “OFF” in the first local table 144. The mobile terminal 100 then sends the notification server 300 a merge request including “ID1-SN1-OFF”, “ID2-SN2-OFF”, and “ID4-SN1-ON” in T380. Further, the mobile terminal 100 deletes the information in the first local table 144 in T382.

In response to receiving the merge request from the mobile terminal 100 in T380, the notification server 300 executes the merge process (see FIG. 4) in T384 to update the user table 344. The notification server 300 first specifies the notification ID “ID1” as the target notification ID from among the notification IDs “ID1”, “ID2”, “ID4” included in the merge request. The notification server 300 then generates target merge information including the notification ID “ID1” (S10). The notification server 300 determines that the combination of the notification ID “ID1” and the serial number “SN1” has been already stored in association with the account information AC1 in the user table 344 (YES in S12). The notification server 300 then determines that the selection information associated with the notification ID “ID1” and the serial number “SN1” indicates “ON” in the user table 344 (YES in S20). In this case, the notification server 300 updates the update information associated with the notification ID “ID1”.

Then, the notification server 300 determines that the check process has not been completed for the notification IDs “ID2”, “ID4” (NO in S30) and specifies the notification ID “ID2” as the target notification ID. The notification server 300 then generates target merge information including the notification ID “ID2” (S10). The notification server 300 determines that the combination of the notification ID “ID2” and the serial number “SN2” has been already stored in association with the account information AC1 in the user table 344 (YES in S12). Further, the notification server 300 determines that the selection information associated with the notification ID “ID2” and the serial number “SN2” indicates “OFF” in the user table 344 (NO in S20). In this case, the notification server 300 overwrites information in the user table 344 with the target merge information and updates the update information (S22).

Then, the notification server 300 determines that the check process has not been completed for the notification ID “ID4” (NO in S30) and generates target merge information including the notification ID “ID4” (S10). The notification server 300 then determines that the combination of the notification ID “ID4” and the serial number “SN1” has been already stored in association with the account information AC1 in the user table 344 (YES in S12). Further, the notification server 300 determines that the selection information associated with the notification ID “ID4” and the serial number “SN1” indicates “OFF” in the user table 344 (NO in S20). In this case, the notification server 300 overwrites information in the user table 344 with the target merge information and updates the update information (S22). As a result, the selection information associated with the notification ID “ID4” changes to “ON” in the user table 344. Then, the notification server 300 determines that the check process has been completed for all the notification IDs (YES in S30) and sends a completion notification to the mobile terminal 100 in T386.

As described above, the notification server 300 receives a merge request from the mobile terminal 100 (T380) after the mobile terminal 100 has shifted from the logout state to the login state. Then, the notification server 300 generates the notification information NT4 corresponding to the notification ID “ID4” the mobile terminal 100 received when it was in the logout state (T384). The notification server 300 then stores the account information AC1, the notification ID “ID1”, the serial number “SN1”, and the notification information NT4 in association with each other in the user table 344 (T384). In this configuration, the notification server 300 can store information corresponding to a notification ID the mobile terminal 100 received when it was in the logout state.

T390 and T392 are the same as T340 and T342 in FIG. 12, respectively. The mobile terminal 100 specifies the user notification information UN4, UN1, UN2 each including the serial number “SN1” or “SN2” stored in the memory 134 from among the received user notification information UN4, UN1, UN3, UN2. The mobile terminal 100 updates the first local table 144 using the specified user notification information UN4, UN1, UN2 in T394. As illustrated in FIG. 16, the mobile terminal 100 stores the user notification information UN4, UN1, UN2 in the first local table 144 and also stores the merge information “ON” in association with the user notification information UN4, UN1, UN2 in the first local table 144.

The user operates the “list” button 606 in the first home screen SC2 in T400 of FIG. 13. In response, the mobile terminal 100 displays a fourth list screen SC40 on the display unit 114 using the first local table 144 in T402. The fourth list screen SC40 includes a seventh notification region 660, an eighth notification region 670, a ninth notification region 680, and a “home” button 630. The seventh notification region 660 corresponds to the user notification information UN4. The seventh notification region 660 includes a selected object 662 and a message region 664. The message region 664 displays the information indicated by the notification information NT4. The eighth notification region 670 corresponds to the user notification information UN1. The eighth notification region 670 is the same as the fifth notification region 640 in the third list screen SC10 (see FIG. 7). The ninth notification region 680 corresponds to the user notification information UN2. The ninth notification region 680 is the same as the sixth notification region 650 in the third list screen SC10 (see FIG. 7).

The user selects the ninth notification region 680 in the fourth list screen SC40 in T410. In response, the mobile terminal 100 uses the URL indicated by the contents information CT2 in the notification-related information NR2 to access the contents server 400. In response to receiving third service screen data representing a third service screen from the contents server 400, the mobile terminal 100 displays the third service screen on the display unit 114 in T412. The third service screen is related to the remote print service. The mobile terminal 100 then changes the selection information associated with the notification ID “ID2” in the first local table 144 to “ON” and sends an update request including “ID2-SN2-ON” to the notification server 300 in T414.

In response to receiving the update request from the mobile terminal 100 in T414, the notification server 300 changes the selection information associated with the notification ID “ID2” and the serial number “SN2” to “ON” in the user table 344 in T416. Thus, selection information in the user table 344 is changed to “ON” in response to a notification screen or a notification region in a list screen being selected.

### Advantageous Effects in Cases A and B

According to the configuration above, the notification server 300 sends the notification information NT1 to the mobile terminal 100 and the PC 200 which use the account information AC1 (T142 in FIG. 5, T212 in FIG. 6). The mobile terminal 100 and the PC 200 then display the notification information NT1 (T152 of FIG. 5, T222 in FIG. 6). Thus, user convenience for the notification information NT1 is improved.

A merge request includes selection information related to selection of notification information. The notification server 300 can store the selection information included in merge requests in the user table 344. This allows for management on whether notification information has been selected or not.

### Correspondence Relationships

The notification server 300 is an example of “server”. The program 340 is an example of “computer-readable instructions for a server”. The mobile terminal 100 is an example of “first terminal device”. The account information AC1 is an example of “specific account information”. The notification information NT1 is an example of “specific notification information”. The notification ID “ID1” is an example of “notification identification information”. The printer 10 is an example of “specific communication device”. The serial number “SN1” is an example of “device identification information”. The merge requests in T130 of FIG. 5 and T380 of FIG. 13 are examples of “first generation request”. The subscription service is an example of “service”. The memory 334 of the notification server 300 is an example of “memory”. The user notification information request in T140 of FIG. 5 is an example of “first request signal”. The PC 200 is an example of “second terminal device”. The user notification information request in T210 of FIG. 6 is an example of “second request signal”. The user notification information UN1 in T142 of FIG. 5 is an example of “first information”. The user notification information UN1 in T212 of FIG. 6 is an example of “second information”. The selection information “OFF” is an example of “first value”. The selection information “ON” is an example of “second value”. The merge request in T200 of FIG. 6 is an example of “second generation request”. The notification-related information request in T356 of FIG. 12 is an example of “third request signal”. The notification-related information request in T116 of FIG. 5 is an example of “fourth request signal”. Operating a “list” button is an example of “predetermined operation”. The notification-related information request in T356 of FIG. 12 is an example of “fifth request signal”.

T130 in FIG. 5 and T380 in FIG. 13 are examples of “receive a first generation request”. T134 in FIG. 5 and T384 in FIG. 13 are examples of “generate the specific notification information” and “store the specific account information, the notification identification information, the device identification information and the specific notification information in association with each other in a memory”. T140 in FIG. 5 and T390 in FIG. 13 are examples of “receive, from the first terminal device, a first request signal”. T142 in FIG. 5 and T392 in FIG. 13 are examples of “send the first terminal device the specific notification information”. T210 in FIG. 6 is an example of “receive, from the second terminal device, a second request signal”. T212 in FIG. 6 is an example of “send the second terminal device the specific notification information”.

The mobile terminal 100 is an example of “terminal device”. The first print application 142 is an example of “computer-readable instructions for a terminal device”.

T130 in FIG. 5 and T380 in FIG. 13 are examples of “send the server a first generation request”. T140 in FIG. 5 and T390 in FIG. 13 are examples of “send the server a first request signal”. T142 in FIG. 5 and T392 in FIG. 13 are examples of “receive, from the server, the specific notification information”. T152 in FIG. 5 and T402 in FIG. 13 are examples of “display the specific notification information on a display of the terminal device”.

T222 in FIG. 6 is an example of “display the specific notification information on a display of the second terminal device”.

(Modification 1) In the above embodiment, the servers 300, 400 are separate servers, however, the servers 300, 400 may be integrated as a single server.

(Modification 2) In the above embodiment, each of the servers 300, 400 is a physical server, however, the servers 300, 400 are not limited to physical servers and may be virtual servers on the cloud or virtual machines. That is, the vendor may use an environment provided by an external cloud computing service without preparing the hardware for the servers 300, 400. In this case, the vendor may implement the servers 300, 400 by preparing programs (i.e., software) for the servers 300, 400 and introducing them to the above environment. In another modification, the servers 300, 400 may be established on the internet 6 by a business operator different from the vendor.

(Modification 3) The “first terminal device” is not limited to the mobile terminal 100 and may be, for example, the PC 200. The “second terminal device” is not limited to the PC 200 and may be, for example, the mobile terminal 100.

(Modification 4) The “device identification information” is not limited to a serial number and may be, for example, an IP address or a MAC address.

(Modification 5) The “service” is not limited to the subscription service and may be, for example, the automatic shipping service or the remote print service.

(Modification 6) The “specific communication device” is not limited to a printer and may be, for example, a multifunctional device, a copying machine, or a sewing machine.

(Modification 7) The “memory” is not limited to the memory 334 of the notification server 300 and may be, for example, a memory of a device different from the notification server 300.

(Modification 8) In S10 of FIG. 4, the notification server 300 may generate target merge information without using the management table 342. Information included in target merge information may be registered by the administrator of the notification server 300, although this is merely an example.

(Modification 9) A merge request may not include selection information.

(Modification 10) In the above embodiment, a merge request includes the selection information “OFF” or the selection information “ON”. However, in a modification, a merge request may include information related to selection of notification information in case notification information has not been selected yet, whereas a merge request may not include the information related to selection of notification information in case notification information has been already selected. In another modification, a merge request may not include information related to selection of notification information in case notification information has not been selected yet, whereas a merge request may include the information related to selection of notification information in case notification information has been already selected.

(Modification 11) The mobile terminal 100 may be configured not to send a merge request in response to the mobile terminal 100 shifting from the logout state to the login state. In this modification, T376, T380, T384, and T386 in FIG. 13 may be omitted. Further, the mobile terminal 100 may be configured not to send a notification-related information request while the mobile terminal 100 is in the logout state. In this modification, “receive, from the first terminal device, a third request signal” and “send the first terminal device the specific notification information and the notification identification information that are not associated with account information in the memory” may be omitted.

(Modification 12) The mobile terminal 100 may be configured not to send a notification-related information request while the mobile terminal 100 is in the logout state. In this modification, “receive, from the first terminal device, a fifth request signal” and “send the first terminal device the specific notification information that is not associated with account information in the memory” may be omitted.

(Modification 13) In the above embodiment, the steps in FIGS. 4, 5, 6, 12, and 13 are implemented by the software (e.g., the programs 140, 142, 240, 242, 340), however, at least one of these steps may be implemented by hardware such as a logic circuit.

What is claimed is:

1. A non-transitory computer-readable recording medium storing computer-readable instructions for a server,
wherein the computer-readable instructions, when executed by a processor of the server, cause the server to:
under a first login state where a first terminal device is logged in to the server using specific account information, receive a first generation request from the first terminal device, the first generation request including notification identification information for identifying specific notification information and device identification information for identifying a specific communication device, and the specific notification information being for notifying a user of the specific communication device of existence of a service for the specific communication device;
in a case where the first generation request is received, generate the specific notification information corresponding to the notification identification information;
after the specific notification information has been generated, store the specific account information, the notification identification information, the device identification information and the specific notification information in association with each other in a memory;
after the specific notification information has been generated, receive, from the first terminal device, a first request signal requesting sending of notification information associated with the specific account information;
in a case where the first request signal is received from the first terminal device, send the first terminal device the specific notification information associated with the specific account information, wherein the first terminal device displays the specific notification information in a case where the specific notification information is received from the server;
after the specific account information, the notification identification information, the device identification information and the specific notification information have been stored in association with each other in the memory and under a second login state where a second terminal device different from the first terminal device is logged in to the server using the specific account information, receive, from the second terminal device, a second request signal requesting sending of notification information associated with the specific account information; and
in a case where the second request signal is received from the second terminal device, send the second terminal device the specific notification information associated with the specific account information, wherein the second terminal device displays the specific notification information in a case where the specific notification information is received from the server.

2. The non-transitory computer-readable recording medium as in claim 1, wherein in the case where the first generation request is received, the specific notification information that is stored in association with the notification identification information in the memory and is not stored in association with account information in the memory is extracted from the memory.

3. The non-transitory computer-readable recording medium as in claim 1, wherein the first generation request indicates either that the specific notification information has not been selected or that the specific notification information has been selected,
wherein in the case where the first request signal is received from the first terminal device, first information including the specific notification information associated with the specific account information is sent to the first terminal device,
wherein in the case where the second request signal is received from the second terminal device, second information including the specific notification information associated with the specific account information is sent to the second terminal device,
wherein in a case where the first generation request indicates that the specific notification information has not been selected, the first information indicates that the specific notification information has not been selected, and
wherein in a case where the first generation request indicates that the specific notification information has been selected, the first information and the second information indicate that the specific notification information has been selected.

4. The non-transitory computer-readable recording medium as in claim 3, wherein the first generation request includes the notification identification information, the device identification information and selection information,
wherein the selection information indicates either a first value indicating that the specific notification information has not been selected or a second value indicating that the specific notification information has been selected,
wherein after the specific notification information has been generated, the specific account information, the notification identification information, the device identification information, the specific notification information and the selection information are stored in association with each other in the memory,
wherein the first information includes the specific notification information and the selection information associated with the specific account information, and
wherein the second information includes the specific notification information and the selection information associated with the specific account information.

5. The non-transitory computer-readable recording medium as in claim 4, wherein the computer-readable instructions, when executed by the processor, further cause the server to:
after the specific account information, the notification identification information, the device identification information, the specific notification information and the selection information indicating the first value have been stored in association with each other in the memory and under the second login state, receive from the second terminal device a second generation request including the notification identification information, the device identification information and the selection information indicating the second value; and
in a case where the second generation request is received, change the selection information associated with the specific account information from the first value to the second value and store the changed selection information in the memory.

6. The non-transitory computer-readable recording medium as in claim 1, wherein the computer-readable instructions, when executed by the processor, further cause the server to:
under a logout state where the first terminal device is not logged in to the server with account information, receive, from the first terminal device, a third request signal requesting sending of notification information that is not associated with account information; and
in a case where the third request signal is received from the first terminal device, send the first terminal device the specific notification information and the notification identification information that are not associated with account information in the memory,
wherein after the logout state has shifted to the first login state, the first generation request is received from the first terminal device.

7. The non-transitory computer-readable recording medium as in claim 1, wherein the computer-readable instructions, when executed by the processor, further cause the server to:
under the first login state, receive from the first terminal device a fourth request signal requesting sending of notification information that is not associated with account information;
in a case where the fourth request signal is received from the first terminal device, send the first terminal device the specific notification information that is not associated with account information in the memory, wherein in a case where the fourth request signal is received again from the first terminal device under the first login state, the specific notification information is not sent, wherein in a case where the specific notification information is received from the server after the first request signal has been sent to the server and a predetermined operation is received, the first terminal device displays the specific notification information, and wherein in a case where the specific notification information is received from the server after the fourth request signal has been sent to the server, the first terminal device displays the specific notification information without receiving the predetermined operation;
after the first login state has shifted to a logout state where the first terminal device is not logged in to the server with account information, receive, from the first terminal device, a fifth request signal requesting sending of notification information that is not associated with account information; and
in a case where the fifth request signal is received from the first terminal device, send the first terminal device the specific notification information that is not associated with account information in the memory, wherein the first terminal device displays the specific notification information without receiving the predetermined operation in a case where the specific notification information is received from the server after the fifth request signal has been sent to the server.

8. A method for displaying a screen on a terminal device, the method comprising:
under a first login state where a first terminal device is logged in to the server using specific account information, receiving a first generation request from the first terminal device, the first generation request including notification identification information for identifying specific notification information and device identification information for identifying a specific communication device, and the specific notification information being for notifying a user of the specific communication device of existence of a service for the specific communication device;
in a case where the first generation request is received, generating the specific notification information corresponding to the notification identification information;
after the specific notification information has been generated, storing the specific account information, the notification identification information, the device identification information and the specific notification information in association with each other in a memory;
after the specific notification information has been generated, receiving, from the first terminal device, a first request signal requesting sending of notification information associated with the specific account information;
in a case where the first request signal is received from the first terminal device, sending the first terminal device the specific notification information associated with the specific account information, wherein the first terminal device displays the specific notification information in a case where the specific notification information is received from the server;
after the specific account information, the notification identification information, the device identification information and the specific notification information have been stored in association with each other in the memory and under a second login state where a second terminal device different from the first terminal device is logged in to the server using the specific account information, receiving, from the second terminal device, a second request signal requesting sending of notification information associated with the specific account information; and
in a case where the second request signal is received from the second terminal device, sending the second terminal device the specific notification information associated with the specific account information, wherein the second terminal device displays the specific notification information in a case where the specific notification information is received from the server.

9. The method as in claim 8, wherein in the case where the first generation request is received, the specific notification information that is stored in association with the notification identification information in the memory and is not stored in association with account information in the memory is extracted from the memory.

10. The method as in claim 8, wherein the first generation request indicates either that the specific notification information has not been selected or that the specific notification information has been selected,
wherein in the case where the first request signal is received from the first terminal device, first information including the specific notification information associated with the specific account information is sent to the first terminal device,
wherein in the case where the second request signal is received from the second terminal device, second information including the specific notification information associated with the specific account information is sent to the second terminal device,
wherein in a case where the first generation request indicates that the specific notification information has not been selected, the first information indicates that the specific notification information has not been selected, and
wherein in a case where the first generation request indicates that the specific notification information has been selected, the first information and the second information indicate that the specific notification information has been selected.

11. The method as in claim 10, wherein the first generation request includes the notification identification information, the device identification information and selection information,
wherein the selection information indicates either a first value indicating that the specific notification information has not been selected or a second value indicating that the specific notification information has been selected,
wherein after the specific notification information has been generated, the specific account information, the notification identification information, the device identification information, the specific notification information and the selection information are stored in association with each other in the memory,
wherein the first information includes the specific notification information and the selection information associated with the specific account information, and
wherein the second information includes the specific notification information and the selection information associated with the specific account information.

12. The method as in claim 11, further comprising:
after the specific account information, the notification identification information, the device identification information, the specific notification information and the selection information indicating the first value have been stored in association with each other in the memory and under the second login state, receiving from the second terminal device a second generation request including the notification identification information, the device identification information and the selection information indicating the second value; and
in a case where the second generation request is received, changing the selection information associated with the specific account information from the first value to the second value and storing the changed selection information in the memory.

13. The method as in claim 8, further comprising:
under a logout state where the first terminal device is not logged in to the server with account information, receiving, from the first terminal device, a third request signal requesting sending of notification information that is not associated with account information; and
in a case where the third request signal is received from the first terminal device, sending the first terminal device the specific notification information and the notification identification information that are not associated with account information in the memory,
wherein after the logout state has shifted to the first login state, the first generation request is received from the first terminal device.

14. A communication system comprising:
a controller;
the controller is configured to:
under a first login state where a first terminal device is logged in to a server using specific account information, receive a first generation request from the first terminal device, the first generation request including notification identification information for identifying specific notification information and device identification information for identifying a specific communication device, and the specific notification information being for notifying a user of the specific communication device of existence of a service for the specific communication device;
in a case where the first generation request is received, generate the specific notification information corresponding to the notification identification information;
after the specific notification information has been generated, store the specific account information, the notification identification information, the device identification information and the specific notification information in association with each other in a memory;
after the specific notification information has been generated, receive, from the first terminal device, a first request signal requesting sending of notification information associated with the specific account information;
in a case where the first request signal is received from the first terminal device, send the first terminal device the specific notification information associated with the specific account information;
in a case where the specific notification information is received from the server, display the specific notification information on a display of the first terminal device;
after the specific account information, the notification identification information, the device identification information and the specific notification information have been stored in association with each other in the memory and under a second login state where a second terminal device different from the first terminal device is logged in to the server using the specific account information, receive, from the second terminal device, a second request signal requesting sending of notification information associated with the specific account information;
in a case where the second request signal is received from the second terminal device, send the second terminal device the specific notification information associated with the specific account information; and
in a case where the specific notification information is received from the server, display the specific notification information on a display of the second terminal device.

15. The communication system as in claim 14, wherein the controller is configured to, in the case where the first generation request is received, extract, from the memory, the specific notification information that is stored in association with the notification identification information in the memory and is not stored in association with account information in the memory.

16. The communication system as in claim 14, wherein the first generation request indicates either that the specific notification information has not been selected or that the specific notification information has been selected,
wherein the controller is configured to, in the case where the first request signal is received from the first terminal device, send, to the first terminal device, first information including the specific notification information associated with the specific account information,
wherein the controller is configured to, in the case where the second request signal is received from the second terminal device, send, to the second terminal device, second information including the specific notification information associated with the specific account information,
wherein in a case where the first generation request indicates that the specific notification information has not been selected, the first information indicates that the specific notification information has not been selected, and
wherein in a case where the first generation request indicates that the specific notification information has been selected, the first information and the second information indicate that the specific notification information has been selected.

17. The communication system as in claim 16, wherein the first generation request includes the notification identification information, the device identification information and selection information,
wherein the selection information indicates either a first value indicating that the specific notification information has not been selected or a second value indicating that the specific notification information has been selected,
wherein the controller is configured to, after the specific notification information has been generated, store the specific account information, the notification identification information, the device identification information, the specific notification information and the selection information in association with each other in the memory,
wherein the first information includes the specific notification information and the selection information associated with the specific account information, and
wherein the second information includes the specific notification information and the selection information associated with the specific account information.

18. The communication system as in claim 17, wherein the controller is further configured to:
after the specific account information, the notification identification information, the device identification information, the specific notification information and the selection information indicating the first value have been stored in association with each other in the memory and under the second login state, receive from the second terminal device a second generation request including the notification identification information, the device identification information and the selection information indicating the second value; and
in a case where the second generation request is received, change the selection information associated with the specific account information from the first value to the second value and store the changed selection information in the memory.

19. The communication system as in claim 14, wherein the controller is further configured to:
under a logout state where the first terminal device is not logged in to the server with account information, receive, from the first terminal device, a third request signal requesting sending of notification information that is not associated with account information; and
in a case where the third request signal is received from the first terminal device, send the first terminal device the specific notification information and the notification identification information that are not associated with account information in the memory,
wherein after the logout state has shifted to the first login state, the first generation request is received from the first terminal device.

20. The communication system as in claim 14, wherein the controller is further configured to:
under the first login state, receive from the first terminal device a fourth request signal requesting sending of notification information that is not associated with account information;
in a case where the fourth request signal is received from the first terminal device, send the first terminal device the specific notification information that is not associated with account information in the memory, wherein in a case where the fourth request signal is received again from the first terminal device under the first login state, the specific notification information is not sent, wherein in a case where the specific notification information is received from the server after the first request signal has been sent to the server and a predetermined operation is received, the first terminal device displays the specific notification information, and wherein in a case where the specific notification information is received from the server after the fourth request signal has been sent to the server, the first terminal device displays the specific notification information without receiving the predetermined operation;
after the first login state has shifted to a logout state where the first terminal device is not logged in to the server with account information, receive, from the first terminal device, a fifth request signal requesting sending of notification information that is not associated with account information; and
in a case where the fifth request signal is received from the first terminal device, send the first terminal device the specific notification information that is not associated with account information in the memory, wherein the first terminal device displays the specific notification information without receiving the predetermined operation in a case where the specific notification information is received from the server after the fifth request signal has been sent to the server.
